(19) United States
(12) Patent Application Publication
(10) Pub. No.: US 2019/0136580 A1
(43) Pub. Date: May 9, 2019

(54) MULTIMODE ELECTRONIC LOCK

(71) Applicant: LifeStyle Lock, LLC, Sharpsburg, GA (US)

(72) Inventors: Donald Matthew Blust, St. Charles, IL (US); Richard James Blust, Sharpsburg, GA (US)

(21) Appl. No.: 16/105,549

(22) Filed: Aug. 20, 2018

Related U.S. Application Data
(60) Provisional application No. 62/548,838, filed on Aug. 22, 2017.

(51) Int. Cl. E05B 47/00; E05B 39/00; G07C 9/00

(52) U.S. Cl. CPC E05B 47/0012; E05B 39/00; G07C 9/00182; E05B 65/5246; E05B 2047/0084; E05B 2047/0095; E05B 2047/0069

(57) ABSTRACT

A multimode electronic lock is disclosed. The lock has three mechanical flag members which move so as to break light beams and detect the position of the flag members, sending a signal to an electronic lock controller. This allows the electronic lock controller to accurately and reliably determine whether the lock is in a locked or unlocked state, regardless of whether an electronic lock/unlock command or a mechanical key and tumbler mechanism was last used to lock or unlock it. Optional features which allow the locking assembly to be secured from transient accelerations/impacts and to move in highly consistent and controllable ways are also disclosed. The electronic lock controller can accept lock/unlock commands from a smartphone or other pairable device, and can lock or unlock the lock according to preprogrammed schedules and/or proximity of the paired device.

### PRIORITY CLAIM AND INCORPORATION BY REFERENCE

This application claims the priority of United States Provisional Patent Application No. 62/548,838, also titled MULTIMODE ELECTRONIC LOCK, with an application filing date of Aug. 22, 2017, filed in the United States Patent and Trademark Office. The invention as disclosed in the 62/548,838 application and as claimed herein was invented by the same inventive entity, and the entirety of the 62/548,838 application is incorporated herein by reference to provide continuity of disclosure.

This invention relates to a multimode electronic lock which allows the use of both traditional mechanical key/tumbler locking means and electronic locking means. The invention allows the use of either the key and tumbler locking means or the electronic locking means while always being aware of whether the lock is engaged or disengaged. The invention also allows the lock to automatically engage or disengage at fixed times and/or when particular events occur.

### BACKGROUND OF THE INVENTION

The present invention relates to a multimode lock with both electronic and mechanical controls. Historically, locks used a key-and-tumbler system wherein a specially shaped key would engage certain tumblers and allow the rotation of a cylinder which engaged or disengaged a locking member. With the advent of electronic technology, various methods of electronically controlling locks including keypads, magnetic stripe swipe cards, and RFID tokens have been used to electronically open locking doors.

It is common for a particular locking device to need both an electronic access feature and a mechanical access feature. Combining these presents a problem because the electronic lock control system must be compatible with and “aware of” the status of the mechanical lock control system. Otherwise it may try to lock an already locked door or vice-versa, confusing the status of the lock. An efficient and reliable system for doing this would be a useful invention.

Further, electronic lock control systems have not historically been adaptable to rapidly changing circumstances or contextual security needs. A locking device which is flexible and adaptable to various contextual data would be a useful invention. Absent evidence of mechanical tampering or attempts to directly influence the electronic lock control system, such locks have also not provided data about attempts to bypass them. A system that provided such information would be a useful invention.

The present invention addresses these concerns.

### SUMMARY OF THE INVENTION

Among the many objectives of the present invention is the provision of a multimode electronic lock.

Another objective of the present invention is the provision of a multimode electronic lock with a mechanical locking system and an electronic locking system.

Another objective of the present invention is the provision of a multimode electronic lock with a mechanical locking system and an electronic locking system which is aware of the status of the mechanical locking system.

Another objective of the present invention is the provision of a multimode electronic lock which can detect potential tampering and alert a user of such potential tampering.

Another objective of the present invention is the provision of a multimode electronic lock which can automatically lock and unlock in response to both the proximity of an unlocking device and/or another predetermined contextual factor.

Other objectives and advantages of the invention will become apparent from the description of the preferred embodiment herein.

### BRIEF DESCRIPTION OF THE DRAWINGS

FIG. 1 depicts a perspective view of the invention incorporated into a locking container.

FIG. 2 depicts a perspective view showing the mechanical unlocking system in a locking container.

FIG. 3 depicts an overhead view of the preferred embodiment of the invention.

FIG. 4 depicts a perspective view of a subassembly of the preferred embodiment of the invention.

FIG. 5 depicts a representative view of the control interface for the electronic locking system.

FIG. 6 depicts a second representative view of the control interface for the electronic locking system.

FIG. 7 depicts a third representative view of the control interface for the electronic locking system.

FIG. 8 depicts a representative view of a user alert after the invention has been tampered with.

FIG. 9 depicts a second representative view of a user alert after the invention has been tampered with.

FIG. 10 depicts a perspective view of the g-lock component.

FIG. 11 depicts a perspective view of the shaft driver.

FIG. 12 depicts a second perspective view of the shaft driver.

FIG. 13 depicts a perspective view of the outer drive cylinder.

FIG. 14 depicts a second perspective view of the outer drive cylinder.

FIG. 15 depicts a perspective view of the inner drive cylinder.

FIG. 16 depicts a second perspective view of the inner drive cylinder.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, may be used with respect to the drawings. These and similar directional terms are not to be construed to limit the scope of the invention in any manner. The words attach, connect, couple, and similar terms with their inflectional morphemes do not necessarily denote direct or intermediate connections, but may also include connections through mediate elements or devices.

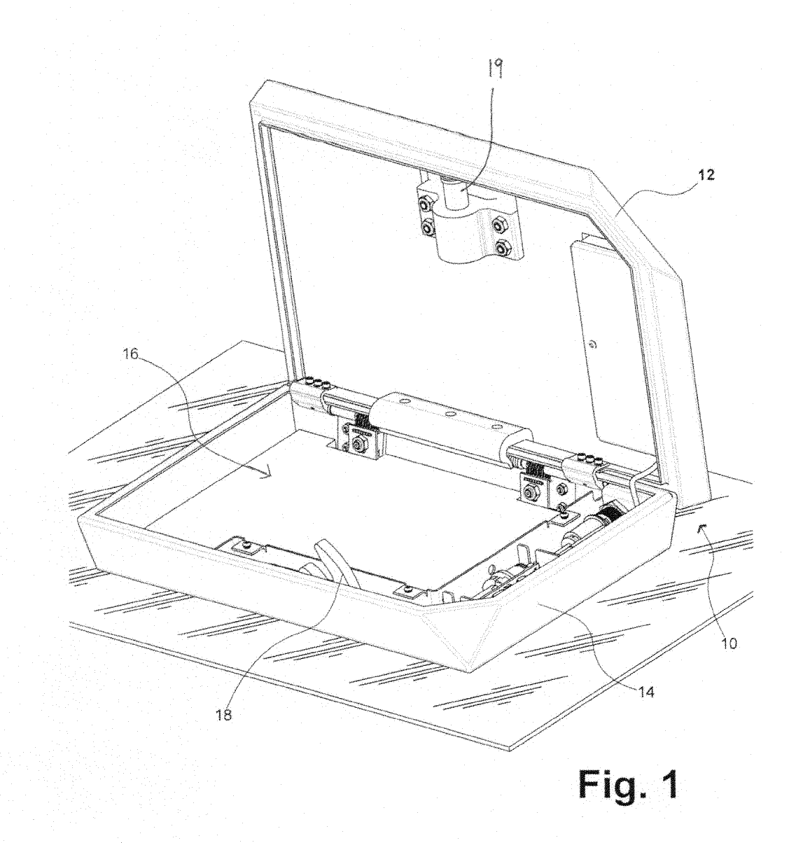

By referring to FIG. 1, the basic function of the invention can be easily understood. Locking box 10 comprises lid 12 and body 14, surrounding storage space 16. Locking member 18 rotates up and engages locking bar 19 in lid 12 to lock locking box 10. When locking member 18 is not engaged, locking box 10 may be opened and closed. The invention allows two different ways for locking member 18 to be engaged or disengaged, and to monitor the status of locking box 10 in relation to its locked/unlocked status and related information about potential tampering.

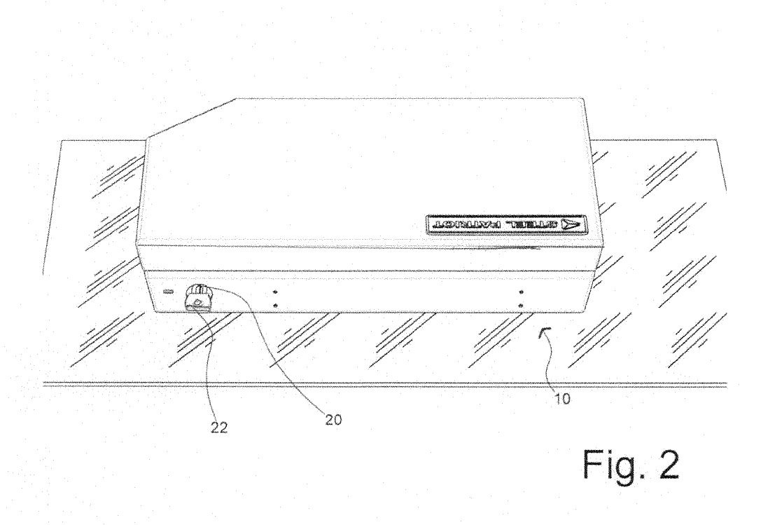

FIG. 2 shows locking box 10 and keyhole 20. Key 22 is inserted into keyhole 20 and may be rotated clockwise or counter-clockwise to lock or unlock the box. It is required that key 22 be rotated to a first position to lock the box and to a second position to unlock the box. It is strongly preferred, but not required, that after locking or unlocking key 22 be rotated to a third position which is the only position that allows removal of key 22 from keyhole 20.

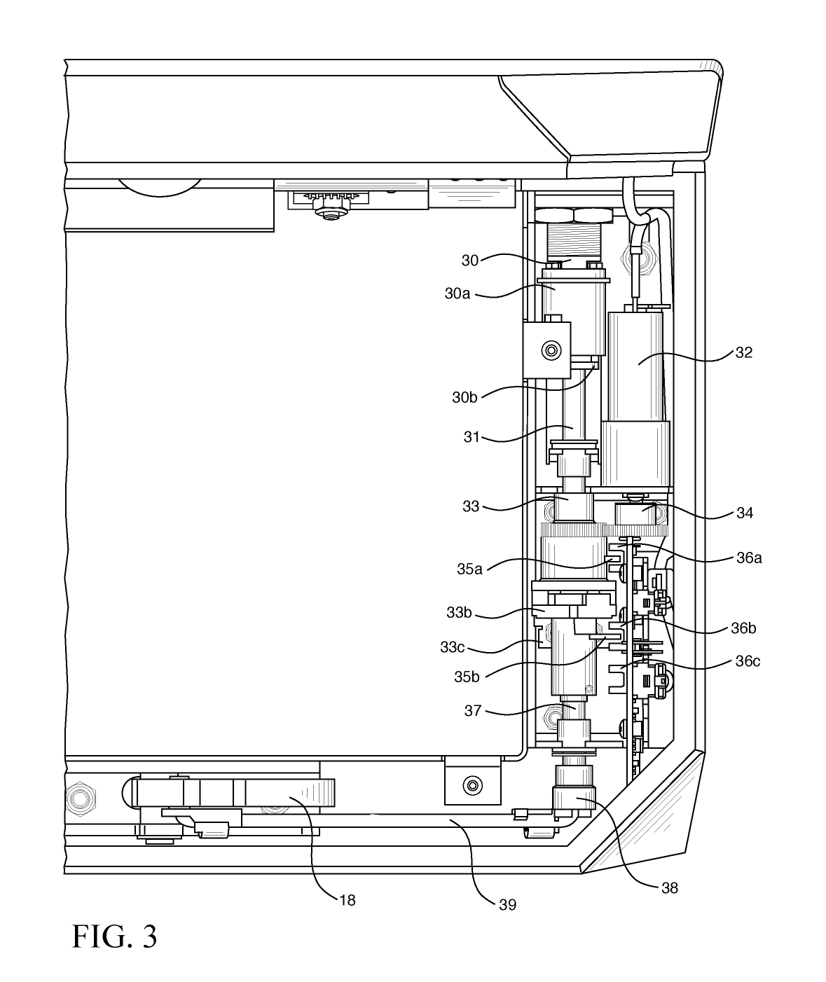

FIG. 3 shows the details of the preferred embodiment of the invention. Note: In all descriptions herein, “left” means the observer's left as they look at FIG. 3, and “right” is the opposite direction. Similarly, a “clockwise” rotation involves rotating part of the assembly, as specified in context and as viewed from above, toward the left side of FIG. 3. A “counter-clockwise” rotation involves a rotation in the opposite direction.

Locking cylinder 30 may be turned by key 22 (not shown: see FIG. 2.) Locking cylinder 30 engages first shaft 31 via a cam-lock coupler comprising outer drive cylinder 30a and corresponding inner drive cylinder 30b that causes first shaft 31 to rotate clockwise when key 22 is rotated clockwise to the limit of its rotation, and vice-versa. When key 22 is rotated away from a limit of rotation, the cam-lock coupler does not cause first shaft 31 to rotate until key 22 passes the removal position, also referred to as the “neutral” position, which is halfway between the two limits of rotation. This allows key 22 to be removed while not causing first shaft 31 to rotate at all, keeping the lock either fully engaged or fully disengaged.

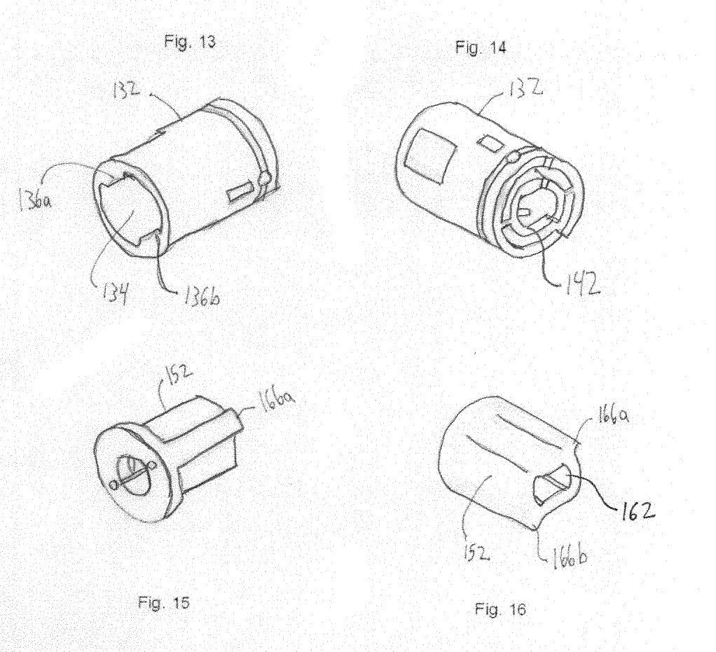

The cam-lock coupler and its embodiment are more completely described in FIGS. 13, 14, 15, and 16.

When first shaft 31 rotates, it causes second shaft 37 to rotate in the same direction. Second shaft 37 can be a second physical shaft operably affixed to first shaft 31, or it can be a single shaft, in which case the entire shaft would be first shaft 31. Second shaft 37 is operably affixed to linkage 38, which rotates in the same direction as second shaft 37. Third shaft 39 is operably affixed to linkage 38, such that when linkage 38 rotates clockwise, third shaft 39 moves toward the left side of FIG. 2, and vice-versa. Third shaft 39 is pivotably affixed to locking member 18, which will raise up into a locked position (engaged with locking pin 19, not shown: see FIG. 1) when third shaft 39 moves to the left and lower down into an unlocked position (disengaged with locking pin 19) when third shaft 39 moves to the right.

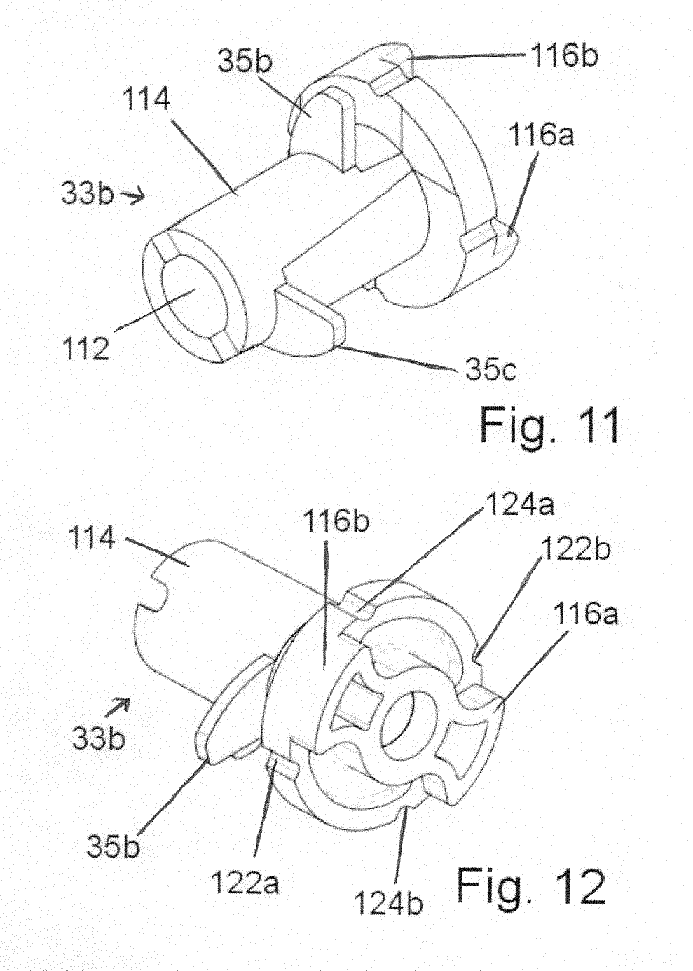

The other method of locking and unlocking the box involves the electronic lock control system, also shown in FIG. 3. Powertrain 32 (in the preferred embodiment, a DC motor, with or without a transmission element as desired) can rotate drive gear 34. When drive gear 34 rotates counter-clockwise, gear member 33 rotates clockwise, and vice-versa. This causes gear member 33 to engage shaft driver 33b, in turn rotating second shaft 37 and thus locking or unlocking the box as described above. Gear member 33 and shaft driver 33b (see FIGS. 11 and 12) engage via a lobe interface that allows shaft driver 33b to rotate with second shaft 37 independent of gear member 33. When second shaft 37 is rotated via the locking cylinder and first shaft 31, gear member 33 does not rotate, but shaft driver 33b, which is operably affixed to second shaft 37, does.

In an alternate embodiment (not shown), the system uses a direct drive system which comprises the entire powertrain and allows the DC motor to directly rotate the shaft.

In another alternate embodiment, which can be combined with the prior alternate embodiment, key 22, locking cylinder 30, and the cam lock coupler assembly can be omitted. In this embodiment, the electronic lock control system is the sole means of locking and unlocking the multimode electronic lock. Such an alternate embodiment can still incorporate the additional improvements described in the figures below.

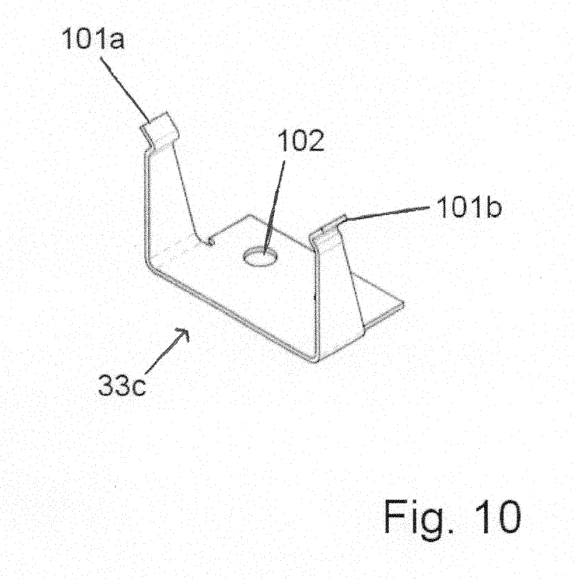

Shaft driver 33b, and through it the entire locking assembly, is braced in its proper location by g-lock 33c. G-lock 33c and its embodiment are more completely described in FIGS. 10, 11, and 12.

The electronic lock control system can detect the locking status of the lock by means of optical sensors, which are incorporated into optical sensor members 36a, 36b, and 36c. Each optical sensor member has a light source in one tine aimed at a light sensor in the opposite tine, incorporating a very small aperture. It is strongly preferred that the aperture be very small relative to the size of the sensor and the light source be aimed very precisely, as this allows the sensors to work properly even in ambient light and to disregard stray light from the other sources.

Optical sensor member 36b detects an “unlocked” condition. When shaft driver 33b is driven counterclockwise by gear member 33 or by (ultimately) locking cylinder 30, flag member 35b moves between the tines of optical sensor 36b, which the electronic control system interprets as “system unlocked.”

Optical sensor member 36c detects a “locked” condition. When shaft driver 33b is driven clockwise by gear member 33 or by (ultimately) locking cylinder 30, flag member 35c (not shown: see FIG. 11) moves between the tines of optical sensor 36c, which the electronic control system interprets as “system locked.” The fact that either optical sensor member 36b or optical sensor member 36c should detect the presence of a flag member at all times can be used as a diagnostic indicator: if neither indicates the presence of a flag member, the electronic lock control system can alert the user via the electronic lock control app. (Not shown: see FIG. 7.)

Optical sensor member 36a detects a “neutral” condition. After each locking or unlocking operation, whether the operation was a result of the electronic lock control system or the use of the key, the lock returns the neutral flag 35a to the neutral condition. Returning the system to the neutral condition allows the lock to be locked or unlocked with the key no matter its prior state or the prior operation.

It will be apparent from the prior description that for any cycle (locked to unlocked or unlocked to locked) the system will go from a non-neutral condition to a neutral condition and back again, such that the key will always lock or unlock the system regardless of what the last command issued by the electronic lock control app was, and the electronic lock control system will always ensure that the lock is either engaged or disengaged as reported by the electronic lock control app regardless of whether the key or the electronic lock control app was last used to lock or unlock the box.

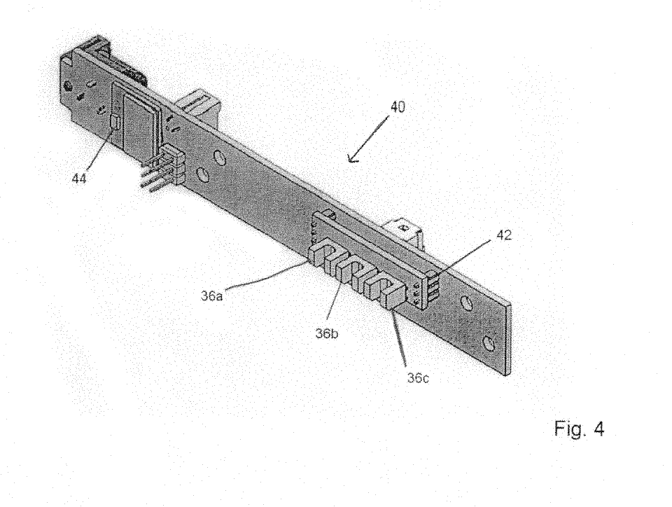

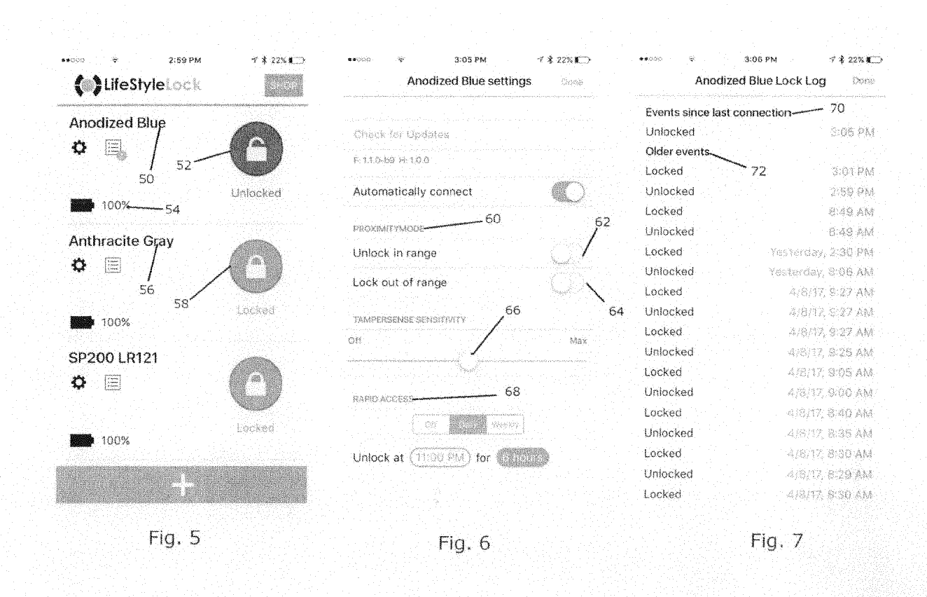

FIG. 4 shows the main assembly for the electronic lock control system. Circuit board 40 is operably attached to wireless interface module 44, which can communicate with a smartphone or other device running the electronic lock control app (not shown: see FIG. 5.) Wireless interface module may be a Bluetooth® module, a NFID sensor, or any other reasonable wireless interface device. (BLUETOOTH is a registered trademark of Bluetooth SIG, Inc.: used for illustration only.) It is preferred, but not required, that wireless interface module 44 not enable commands to be received or information to be transmitted via the global computer network. It is strongly preferred, but not required, that wireless interface module 44 interact with the electronic lock control app through a secure encrypted pairing or linking protocol.

Sensor assembly 42 incorporates optical sensor members 36a, 36b, and 36c. These are mechanically mounted and electronically connected to the electronic lock control system, which is powered by a battery or other rechargeable/replaceable internal power source (not shown) and ultimately run by one or more integrated circuits (not shown) as will be apparent to persons of ordinary skill in the art.

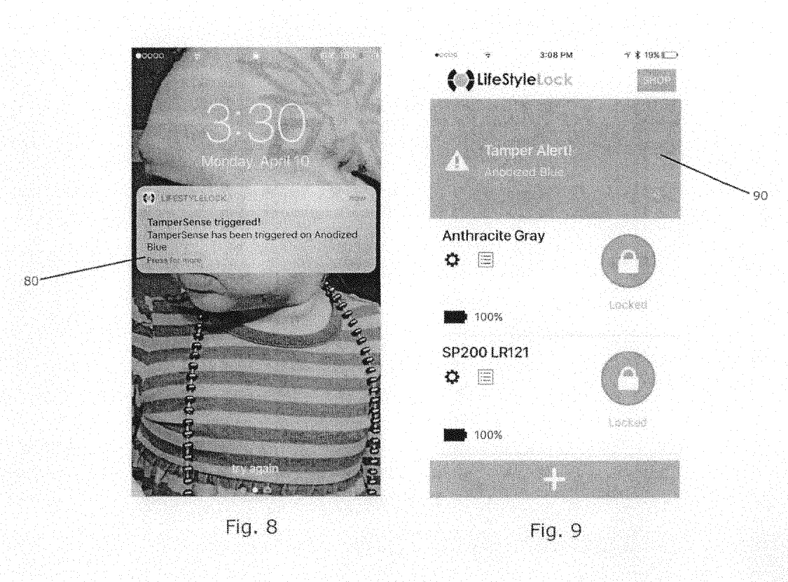

FIG. 5 shows the interface for the electronic lock control app running on a smartphone or other suitable device. Multiple electronic lock control systems can be run from a single app interface: shown here are three including Anodized Blue box 50 and Anthracite Gray box 56, each an identifier for an individual locking box (not shown.) First status controller 52 shows that Anodized Blue box 50 is unlocked, and second status controller 58 shows that Anthracite Gray box 56 is locked. Any reasonable means may be used to send a lock or unlock signal to the boxes: in the preferred embodiment, tapping on a status controller will send a signal to the associated box which will toggle it from locked to unlocked or vice versa. The electronic lock control app also incorporates a battery status indicator for each box, for example first battery status indicator 54, which shows that the battery for Anodized Blue box 50 is at 100% charge. The electronic control app could also push notifications (not shown: see FIG. 8) to the user if the battery level is below a certain threshold.

FIG. 6 shows the electronic lock control app settings screen for a given locking box, here Anodized Blue box 50 (not shown.) Features include the ability to automatically connect when in range, a Proximity Mode control set, a TamperSense Sensitivity control, and a Rapid Access control set.

Proximity Mode control set 60 includes “Unlock In Range” toggle 62 and “Lock Out Of Range” toggle 64. When the former is activated, the electronic lock control system will automatically unlock the box when it determines that the device running the electronic lock control app is within a defined proximity of the box. This can be determined by radio signal strength or by binary detection/nondetection of the device. When the latter is activated, the electronic lock control system will automatically lock the box when it determines that the device running the electronic lock control app is not within a defined proximity of the box. This can be determined by radio signal strength or by binary detection/nondetection of the device. The features can be engaged and disengaged independently.

TamperSense sensitivity control 66 allows the sensitivity of the TamperSense system to be controlled, including setting it to zero sensitivity or “Off.” The electronic lock control system includes one or more tamper detection sensors (not shown) which will transmit information to the electronic lock control app when they detect a tamper event (e.g. a sudden acceleration or an attempt to turn the locking cylinder without the key inserted) which exceeds the sensitivity setting. An alert can then be shown (see FIG. 8) and an event logged (see FIG. 7.) If wireless interface module 44 does allow information to be sent via the global computer network, the alert can be sent via the global computer network to the electronic lock control app to notify the user anywhere in the world.

Rapid Access control set 68 allows rapid access parameters to be set. For example, as shown the electronic lock control system could be instructed to unlock the system every night at 11 PM for 6 hours. If the box contains, as an example, an emergency medical item, this would ensure that the item could be obtained quickly even by a person just waking from sleep and in an excited state which might prevent them from operating the electronic lock control app quickly. A similar system could be used to automatically lock the box at certain times, such as on weekends during the day when young children will be home from school and could be unattended for periods of time. It is strongly preferred, but not required, that the individual status controllers (not shown: see FIG. 5) override both the Proximity Mode and Rapid Access control sets.

FIG. 7 shows the Lock Log, a list of events maintained by the electronic lock control system and stored on the electronic lock control app. These events can be any events which the electronic lock control system can detect, including locking, unlocking, tampering, or any other reasonably detectable event. It is preferred, but not required, to maintain the Lock Log in two sections, for example “Events Since Last Connection” section 70 and “Older Events” section 72. This allows the user to quickly determine which logged events are new since the last time they reviewed the status of the device.

FIG. 8 shows a “push” notification sent to the device running the electronic lock control app. Here, a TamperSense event has been detected, which the electronic lock control app has “pushed” to the main screen of the device via alert dialog 80. The user will see alert dialog 80 as soon as they look at the device, regardless of whether they are actively interacting with the electronic lock control app. It is preferred, but not required, that tapping such a push notification will immediately open the electronic lock control app and allow the user to retrieve information regarding the status of the lock.

FIG. 9 shows a detailed TamperSense information screen in the electronic lock control app. Tamper alert 90 indicates that Anodized Blue box 50 (not shown: see FIG. 5) has been tampered with. This tells the user to investigate that box and check it for unauthorized access or damage. It is optional to present specific information about the tamper event, if available. For example, the alert could indicate “strong impact detected” or “attempt to unlock without key present detected.” This could also include potential electronic tamper events, if desired, such as “Five or more unauthorized pairing attempts detected.”

FIG. 10 depicts g-lock 33c, which provides indexed support to shaft driver 33b. G-lock 33c is fastened to interior 16 of box 10 (not shown, see FIG. 1) via mounting hole 102 in such a way that spring arms 101a and 101b prevent shaft driver 33b from moving due to transient accelerations or “g-shocks” of box 10, such as would occur if box 10 were dropped, shaken, or impacted by something. This prevents the entire locking assembly from moving, losing alignment, or breaking fee of its mountings. It is strongly preferred, but not required, to include g-lock 33c, as if the entire locking assembly moves, loses alignment, or breaks free of its mountings, locking member 18 (not shown: see FIG. 1) can become disengaged from locking pin 19 (not shown: see FIG. 1) and lid 12 (not shown: see FIG. 1) can be opened without the key or authorized instructions to open from the electronic lock control app.

Spring arms 101a and 101b engage detents on shaft driver 33b (see FIG. 12) such that when shaft driver 33b is in either the locked or unlocked position, one or the other set of detents will be engaged with the spring arms, providing indexed support and helping maintain a specific and positive orientation of the entire locking assembly.

FIGS. 11 and 12 depict shaft driver 33b. Shaft driver 33b includes body 114, which has shaft-tube 112 through which second shaft 37 (not shown: see FIG. 3) passes in a manner which affixes it to second shaft 37, such that when shaft driver 33b turns, so does second shaft 37. This can be accomplished by providing an interrupted circumference which engages with an inverse surface in shaft-tube 112 (e.g. a flat surface on the inside of shaft-tube 112 which engages a corresponding flat surface defined by a chord of second shaft 37) or by any other reasonable means.

Body 114 is operably affixed with cam lobes 116a and 116b. These engage with corresponding lobes on gear member 33 (not shown: see FIG. 3) such that when gear member 33 rotates, shaft driver 33b rotates in the same direction, but only during that portion of the rotational travel of gear member 33 wherein cam lobes 116a and 116b are engaged with the corresponding lobes of gear member 33. This allows the locking assembly to return to the neutral position.

Detents 122a and 122b, and 124a and 124b, form two corresponding pairs of detents respectively. When shaft driver 33b is in the locked position, detents 124a and 124b engage spring arms 101a and 101b (not shown: see FIG. 10.) When shaft driver 33b is in the unlocked position, detents 122a and 122b engage spring arms 101a and 101b (not shown: see FIG. 10.) In either position the combination of the spring arms and the detents hold the locking assembly in the proper position and resist unwanted rotation or lateral movement. It is required that the tension on the spring arms not cause so much frictional force that powertrain 32 cannot rotate second shaft 37 by applying a reasonable amount of force.

Flag members 35b and 35c are mounted on shaft driver 33b (here, they are extrusions of body 114) such that they will interact with optical sensor members 36b and 36c (not shown: see FIG. 3) when shaft driver 33b is in the corresponding locked or unlocked position. This allows the electronic lock control system to reliably and consistently confirm the locked or unlocked state of the system, because second shaft 37, operably affixed to shaft driver 33b, is mechanically coupled with locking member 18 such that the position of second shaft 37 is a reliable indicator of the position of locking member 18.

FIGS. 13 and 14 show the outer drive cylinder component of the cam-lock coupler assembly. (Referred to in FIG. 3 as outer drive cylinder 30a.) Outer body 132 interfaces with locking cylinder 30 (not shown: see FIG. 3) through lock cylinder interface 142. Outer body 132 defines outer sleeve 134, which has an interior circumference interrupted by outer lobes 136a and 136b.

FIGS. 15 and 16 show the inner drive cylinder component of the cam-lock coupler assembly. (Referred to in FIG. 3 as inner drive cylinder 30b.) Inner body 152 interfaces with first shaft 31 (not shown: see FIG. 3) via keyed sleeve 162. Inner body 152 has an exterior circumference interrupted by inner lobes 166a and 166b.

When inner body 152 is inserted into outer body 132, they form the cam-lock coupler. Locking cylinder 30 (not shown: see FIG. 3) rotates outer body 132. If the locking cylinder is rotated from neutral to locked when the lock is unlocked, outer lobes 136a and 136b will engage inner lobs 166a and 166b, turning first shaft 31 (not shown: see FIG. 3) and changing the lock from locked to unlocked or vice versa. If the electronic locking system changes from locked to unlocked or vice versa, and the locking cylinder is already in the corresponding position, the outer lobes will not engage the inner lobes, and the locking cylinder will remain in its current state. This configuration allows reliable, consistent and positive interaction of the mechanical and electronic locking components of the lock.

While various embodiments and aspects of the present invention have been described above, it should be understood that they have been presented by way of example only, and not limitation. Thus, the breadth and scope of the present invention should not be limited by any of the above exemplary embodiments.

This application—taken as a whole with the abstract, specification, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

What is claimed and sought to be protected by Letters Patent is:

1) A multimode electronic lock comprising:
a) A locking cylinder which can be rotated by a key;
b) A shaft operably affixed to the locking cylinder which rotates when the key is rotated;
c) An electronic lock control system including a wireless interface module and a powertrain, the powertrain including a drive motor able to rotate the shaft either directly or by means of an optional gear member;
d) A lock condition sensor which electronically communicates with the electronic lock control system and allows the electronic lock control system to confirm that the multimode electronic lock is in a locked condition;
e) An unlock condition sensor which electronically communicates with the electronic lock control system and allows the electronic lock control system to confirm that the multimode electronic lock is in an unlocked condition;
f) A neutral condition sensor which electronically communicates with the electronic lock control system and allows the electronic lock control system to confirm that the powertrain is in a neutral position;
g) An electronic device running an electronic lock control app, the electronic device able to communicate with the electronic lock control system via the wireless interface module; and,
h) A locking member operably affixed to the shaft such that when either the key is rotated in the locking cylinder or the electronic control system activates the powertrain, the locking member engages or disengages a second locking member, locking or unlocking the multimode electronic lock.

2) A multimode electronic lock as in claim 1, wherein the electronic lock control app includes a proximity sense control which can lock or unlock the multimode electronic lock when the electronic device is within or without a defined proximity to the multimode electronic lock.

3) A multimode electronic lock as in claim 1, wherein the electronic lock control system includes a tamper detection feature which can alert a user via the lock control app if the multimode electronic lock is tampered with.

4) A multimode electronic lock as in claim 1, wherein the electronic lock control app includes a rapid access control which allows a user to set a predetermined time range during which the multimode electronic lock will automatically lock or unlock.

5) A multimode electronic lock as in claim 1, further comprising:
a) A cam-lock coupler, the cam-lock coupler comprising an outer drive cylinder and an inner drive cylinder, the outer drive cylinder being operably affixed to the locking cylinder, the inner drive cylinder being inserted into the outer drive cylinder, and the inner drive cylinder being operably affixed to the shaft;
b) A plurality of inner lobes, the inner lobes interrupting an interior circumference of the outer drive cylinder; and,
c) A plurality of outer lobes, the outer lobes interrupting an exterior circumference of the inner drive cylinder, such that when the inner drive cylinder or the outer drive cylinder rotates through a circular rotation, the outer lobes become engaged with the inner lobes during a first part of the circular rotation, and become disengaged from the inner lobes during a second part of the circular rotation.

6) A multimode electronic lock as in claim 1, wherein the key can rotate the locking cylinder into a key lock position, a key neutral position, and a key unlock position, with the key neutral position being located between the key lock position and the key unlock position, the key neutral position corresponding to the powertrain being in the neutral position, and wherein the key can be inserted into or removed from the locking cylinder only when the locking cylinder is in the key neutral position.

7) A multimode electronic lock as in claim 2, wherein the key can rotate the locking cylinder into a key lock position, a key neutral position, and a key unlock position, with the key neutral position being located between the key lock position and the key unlock position, the key neutral position corresponding to the powertrain being in the neutral position, and wherein the key can be inserted into or removed from the locking cylinder only when the locking cylinder is in the key neutral position.

8) A multimode electronic lock as in claim 3, wherein the key can rotate the locking cylinder into a key lock position, a key neutral position, and a key unlock position, with the key neutral position being located between the key lock position and the key unlock position, the key neutral position corresponding to the powertrain being in the neutral position, and wherein the key can be inserted into or removed from the locking cylinder only when the locking cylinder is in the key neutral position.

9) A multimode electronic lock as in claim 4, wherein the key can rotate the locking cylinder into a key lock position, a key neutral position, and a key unlock position, with the key neutral position being located between the key lock position and the key unlock position, the key neutral position corresponding to the powertrain being in the neutral position, and wherein the key can be inserted into or removed from the locking cylinder only when the locking cylinder is in the key neutral position.

10) A multimode electronic lock as in claim 5, wherein the key can rotate the locking cylinder into a key lock position, a key neutral position, and a key unlock position, with the key neutral position being located between the key lock position and the key unlock position, the key neutral position corresponding to the powertrain being in the neutral position, and wherein the key can be inserted into or removed from the locking cylinder only when the locking cylinder is in the key neutral position.

11) A multimode electronic lock as in claim 1, further comprising:
a) A first end of the shaft, the first end of the shaft being operably affixed to the locking cylinder;
b) A second end of the shaft, the second end of the shaft being operably affixed to a right-angle linkage, the right-angle linkage having a range of movement substantially at right angles to an axis of the shaft such that when the shaft rotates the right-angle linkage moves through the range of movement at substantially a right angle to an axis of rotation of the shaft; and,
c) A linking arm, the linking arm being operably affixed to the right-angle linkage and to the locking member, such that when the right-angle linkage moves at substantially a right angle to an axis of rotation of the shaft, the linking arm causes the locking member to engage or disengage with the second locking member.

12) A multimode electronic lock as in claim 2, further comprising:
a) A first end of the shaft, the first end of the shaft being operably affixed to the locking cylinder;
b) A second end of the shaft, the second end of the shaft being operably affixed to a right-angle linkage, the right-angle linkage having a range of movement substantially at right angles to an axis of the shaft such that when the shaft rotates the right-angle linkage moves through the range of movement at substantially a right angle to an axis of rotation of the shaft; and,
c) A linking arm, the linking arm being operably affixed to the right-angle linkage and to the locking member, such that when the right-angle linkage moves at substantially a right angle to an axis of rotation of the shaft, the linking arm causes the locking member to engage or disengage with the second locking member.

13) A multimode electronic lock as in claim 3, further comprising:
a) A first end of the shaft, the first end of the shaft being operably affixed to the locking cylinder;
b) A second end of the shaft, the second end of the shaft being operably affixed to a right-angle linkage, the right-angle linkage having a range of movement substantially at right angles to an axis of the shaft such that when the shaft rotates the right-angle linkage moves through the range of movement at substantially a right angle to an axis of rotation of the shaft; and,
c) A linking arm, the linking arm being operably affixed to the right-angle linkage and to the locking member, such that when the right-angle linkage moves at substantially a right angle to an axis of rotation of the shaft, the linking arm causes the locking member to engage or disengage with the second locking member.

14) A multimode electronic lock as in claim 4, further comprising:
a) A first end of the shaft, the first end of the shaft being operably affixed to the locking cylinder;
b) A second end of the shaft, the second end of the shaft being operably affixed to a right-angle linkage, the right-angle linkage having a range of movement substantially at right angles to an axis of the shaft such that when the shaft rotates the right-angle linkage moves through the range of movement at substantially a right angle to an axis of rotation of the shaft; and,
c) A linking arm, the linking arm being operably affixed to the right-angle linkage and to the locking member, such that when the right-angle linkage moves at substantially a right angle to an axis of rotation of the shaft, the linking arm causes the locking member to engage or disengage with the second locking member.

15) A multimode electronic lock as in claim 5, further comprising:
a) A first end of the shaft, the first end of the shaft being operably affixed to the locking cylinder;
b) A second end of the shaft, the second end of the shaft being operably affixed to a right-angle linkage, the right-angle linkage having a range of movement substantially at right angles to an axis of the shaft such that when the shaft rotates the right-angle linkage moves through the range of movement at substantially a right angle to an axis of rotation of the shaft; and,
c) A linking arm, the linking arm being operably affixed to the right-angle linkage and to the locking member, such that when the right-angle linkage moves at substantially a right angle to an axis of rotation of the shaft, the linking arm causes the locking member to engage or disengage with the second locking member.

16) A multimode electronic lock as in claim 6, further comprising:
d) A first end of the shaft, the first end of the shaft being operably affixed to the locking cylinder;
a) A second end of the shaft, the second end of the shaft being operably affixed to a right-angle linkage, the right-angle linkage having a range of movement substantially at right angles to an axis of the shaft such that when the shaft rotates the right-angle linkage moves through the range of movement at substantially a right angle to an axis of rotation of the shaft; and,
b) A linking arm, the linking arm being operably affixed to the right-angle linkage and to the locking member, such that when the right-angle linkage moves at substantially a right angle to an axis of rotation of the shaft, the linking arm causes the locking member to engage or disengage with the second locking member.

17) multimode electronic lock as in claim 7, further comprising:
a) A first end of the shaft, the first end of the shaft being operably affixed to the locking cylinder;
b) A second end of the shaft, the second end of the shaft being operably affixed to a right-angle linkage, the right-angle linkage having a range of movement substantially at right angles to an axis of the shaft such that when the shaft rotates the right-angle linkage moves through the range of movement at substantially a right angle to an axis of rotation of the shaft; and,
c) A linking arm, the linking arm being operably affixed to the right-angle linkage and to the locking member, such that when the right-angle linkage moves at substantially a right angle to an axis of rotation of the shaft, the linking arm causes the locking member to engage or disengage with the second locking member.

18) A multimode electronic lock as in claim 8, further comprising:
a) A first end of the shaft, the first end of the shaft being operably affixed to the locking cylinder;
b) A second end of the shaft, the second end of the shaft being operably affixed to a right-angle linkage, the right-angle linkage having a range of movement substantially at right angles to an axis of the shaft such that when the shaft rotates the right-angle linkage moves through the range of movement at substantially a right angle to an axis of rotation of the shaft; and,
c) A linking arm, the linking arm being operably affixed to the right-angle linkage and to the locking member, such that when the right-angle linkage moves at substantially a right angle to an axis of rotation of the shaft, the linking arm causes the locking member to engage or disengage with the second locking member.

19) A multimode electronic lock as in claim 9, further comprising:
a) A first end of the shaft, the first end of the shaft being operably affixed to the locking cylinder;
b) A second end of the shaft, the second end of the shaft being operably affixed to a right-angle linkage, the right-angle linkage having a range of movement substantially at right angles to an axis of the shaft such that when the shaft rotates the right-angle linkage moves through the range of movement at substantially a right angle to an axis of rotation of the shaft; and,
c) A linking arm, the linking arm being operably affixed to the right-angle linkage and to the locking member, such that when the right-angle linkage moves at substantially a right angle to an axis of rotation of the shaft, the linking arm causes the locking member to engage or disengage with the second locking member.

20) A multimode electronic lock as in claim 10, further comprising:
a) A first end of the shaft, the first end of the shaft being operably affixed to the locking cylinder;
b) A second end of the shaft, the second end of the shaft being operably affixed to a right-angle linkage, the right-angle linkage having a range of movement substantially at right angles to an axis of the shaft such that when the shaft rotates the right-angle linkage moves through the range of movement at substantially a right angle to an axis of rotation of the shaft; and,
c) A linking arm, the linking arm being operably affixed to the right-angle linkage and to the locking member, such that when the right-angle linkage moves at substantially a right angle to an axis of rotation of the shaft, the linking arm causes the locking member to engage or disengage with the second locking member.

21) A multimode electronic lock as in claim 2, wherein the electronic lock control system includes a tamper detection feature which can alert a user if the multimode electronic lock is tampered with.

22) A multimode electronic lock as in claim 21, wherein the electronic lock control system includes a rapid access control which allows a user to set a predetermined time range during which the multimode electronic lock will automatically lock or unlock.
